(19) United States
(12) Patent Application Publication
(10) Pub. No.: US 2017/0174034 A1
(43) Pub. Date: Jun. 22, 2017

(54) CONTROL DEVICE FOR VEHICLE SUSPENSION

(71) Applicant: TOYOTA JIDOSHA KABUSHIKI KAISHA, Toyota-shi (JP)

(72) Inventor: Yanqing LIU, Susono-shi (JP)

(73) Assignee: TOYOTA JIDOSHA KABUSHIKI KAISHA, Toyota-shi (JP)

(21) Appl. No.: 15/350,546

(22) Filed: Nov. 14, 2016

(30) Foreign Application Priority Data
Dec. 21, 2015 (JP) 2015-248423

(51) Int. Cl. B60G 17/0165; B60G 17/019

(52) U.S. Cl. CPC B60G 17/0165; B60G 17/01908

(57) ABSTRACT

A vehicle suspension includes a shock absorber whose damping coefficient is variable. A control device includes: a road surface input sensor that generates a first signal corresponding to a vertical movement of each wheel; a sprung mass behavior sensor that generates a second signal corresponding to a vertical movement of a vehicle body at a position of each wheel; and a control unit that controls the damping coefficient. The control unit performs: a normal control that sets the damping coefficient to a hard-side value with regard to a wheel where the second signal indicates occurrence of a sprung mass behavior exceeding a standard; and a rear wheel softening control that sets the damping coefficient regarding a rear wheel to a soft-side value lower than the hard-side value, when determining, based on the first signal, that a rear-wheel-rising-time-point when the rear wheel reaches a rising point on a road surface comes.

### BACKGROUND

Technical Field

The present invention relates to a control device for a vehicle suspension, particularly to a control device for a vehicle suspension capable of changing a damping coefficient.

Background Art

Patent Literature 1 discloses a suspension device that can change, as appropriate, a damping coefficient of a shock absorber provided to each wheel. According to this suspension device, the damping coefficient of the shock absorber of each wheel is controlled in response to a variety of requests. When a front wheel of a vehicle goes over a bump, the damping coefficient of the shock absorber of a rear wheel is set to be a soft-side value until the rear wheel overcomes the bump, regardless of other control requests (see the third embodiment and FIG. 10).

According to the control mentioned above, the damping coefficient of the shock absorber of the rear wheel is surely the soft-side value at a time when the rear wheel goes over a bump after the front wheel overcomes the bump. Therefore, the suspension device disclosed in Patent Literature 1 can prevent a strong shock from being transmitted to a vehicle body when the rear wheel goes over the bump that front wheel has previously overcome, and thus can achieve a comfortable ride.

### LIST OF RELATED ART

Patent Literature 1: JP 2010-235019 A

Patent Literature 2: JP 2015-77813 A

### SUMMARY

However, when the front wheel of the vehicle crosses a bump, it exerts an influence also on a suspension of the rear wheel. At this time, if the damping coefficient of the shock absorber of the rear wheel is the soft-side value, a strong pitch is likely to occur on the vehicle body. In this regard, the suspension device as set forth in Patent Literature 1 has a problem in that a strong pitch behavior is likely to occur when the front wheel crosses the bump, although the suspension device is effective for suppressing push-up when the rear wheel goes over the bump that front wheel has previously overcome.

The present invention has been made to solve the problem described above. An object of the present invention is to provide a control device for a vehicle suspension that can suppress a pitch behavior at a time when a front wheel crosses a bump and maintain a comfortable ride at a time when a rear wheel crosses the bump.

A first invention has the following features in order to achieve the object described above. The first invention provides a control device for a vehicle suspension. The vehicle suspension includes a spring element and a shock absorber whose damping coefficient is variable, the spring element and the shock absorber being provided for each wheel of a vehicle. The control device includes: a road surface input sensor configured to generate a signal corresponding to a vertical movement of the each wheel; a sprung mass behavior sensor configured to generate a signal corresponding to a vertical movement of a vehicle body at a position of the each wheel; and a control unit configured to supply, based on the signal from the road surface input sensor and the signal from the sprung mass behavior sensor, a command signal specifying the damping coefficient to the shock absorber of the each wheel. The control unit performs: a normal control that sets the damping coefficient to a hard-side value with regard to a wheel at a position where determination based on the signal from the sprung mass behavior sensor indicates occurrence of a sprung mass behavior exceeding a standard; and a rear wheel softening control that sets the damping coefficient regarding a rear wheel to a soft-side value lower than the hard-side value, when determining, based on the signal from the road surface input sensor, that a rear-wheel-rising-time-point when the r eel reaches a rising point on a road surface comes.

A second invention has the following features in addition to the first invention. The control device further includes a vehicle speed sensor configured to generate a signal corresponding to a vehicle speed. The rear wheel softening control includes: a computation process of computing, based on the signal from the road surface input sensor, a front-wheel-rising-time-point when a front wheel reaches the rising point on the road surface; a process of calculating, based on the vehicle speed and a wheelbase, a required time from the front-wheel-rising-time-point to the rear-wheel-rising-time-point; and a command process of outputting a change command of changing the damping coefficient such that the damping coefficient is switched when the required time elapses after the front-wheel-rising-time-point.

A third invention has the following features in addition to the second invention. The computation process includes: a process of calculating, based on the signal from the road surface input sensor, a road plane amount corresponding to an average height of the road surface; a process of computing, based on the signal from the road surface input sensor on a side of the front wheel, a vertical position of the front wheel; a process of computing, based on the signal from the road surface input sensor on a side of the rear wheel, a vertical position of the rear wheel; and a process of setting, as the front-wheel-rising-time-point, a time point when a difference between the vertical position of the front wheel and the road plane amount exceeds a threshold while a difference between the vertical position of the rear wheel and the road plane amount remains less than the threshold.

A fourth invention has the following features in addition to the second or third invention. The computation process and the command process are performed independently for each of a pair of a left front wheel and a left rear wheel and a pair of a right front wheel and a right rear wheel.

A fifth invention has the following features in addition to any one of the second to fourth inventions. The command process includes: a process of reading a time lag from an output time of the change command to a time when the damping coefficient is actually changed; and a process of outputting the change command the time lag before a time point when the required time elapses after the front-wheel-rising-time-point.

According to the first invention, the damping coefficient of the shock absorber is set to the hard-side value at a wheel position where a sprung mass behavior exceeding a standard is occurring. When the front wheel goes over the rising point on the road surface, the resultant oscillation is transmitted to the rear wheel, which may cause a significant sprung mass behavior on the rear wheel side. In such the case, the damping coefficient on the rear wheel side is set to the hard-side value according to the present invention, and thus a pitch behavior of the vehicle can be suppressed. A running path of the rear wheel is highly likely to overlap the rising point on the road surface that the front wheel has crossed. If the damping coefficient regarding the rear wheel is kept at the hard-side value even when the rear wheel crosses the rising point, a strong push-up force is likely to be transmitted to a passenger in the vehicle, which can cause deterioration of the ride comfort of the vehicle. According to the present invention, when the rear wheel reaches the rising point on the road surface, the damping coefficient regarding the rear wheel is set to the soft-side value by the rear wheel softening control. Accordingly, the present invention can give the passenger a comfortable ride when the rear wheel crosses the rising point.

Moreover, according to the first invention, it is possible to achieve the normal control that suppresses a sprung mass behavior with a sprung mass velocity exceeding a standard value. According to such the normal control, it is possible to properly achieve both stabilization of a vehicle attitude and the comfortable ride.

According to the second invention, the required time from a time point when the front wheel reaches the rising point on the road surface to a time point when the rear wheel reaches the rising point can be accurately calculated based on the vehicle speed and the wheelbase. In this case, a time point when the required time has elapsed after the front-wheel-rising-time-point corresponds exactly to the rear-wheel-rising-time-point. In order to achieve both the suppression of the pitch behavior and the ensuring of the comfortable ride, it is desirable that switching of the damping coefficient is executed exactly at the rear-wheel-rising-time-point. The present invention can properly meet such the requirement.

According to the third invention, the front-wheel-rising-time point is a time point when a condition that the vertical position of the rear wheel does not so differ from the road plane amount but the vertical position of the front wheel differs greatly from the road plane amount is satisfied. When the front wheel reaches the rising point on the road surface, the vertical position of the front wheel changes, and thus only the vertical position of the front wheel departs from the road plane amount. According to the present invention, it is possible to detect occurrence of such the situation to precisely determine the front-wheel-rising-time-point.

According to the fourth invention, the control is performed independently for each of a pair of a left front wheel and a left rear wheel and a pair of a right front wheel and a right rear wheel. Therefore, both a stable vehicle behavior and the comfortable ride can be achieved at a high level.

According to the fifth invention, a response delay time due to a time lag of an actuator or the like is taken into consideration, and the change command can be output the response delay time before a time point when the rear wheel actually reaches the rising point on the road surface. Therefore, according to the present invention, the damping coefficient regarding the rear wheel can be switched exactly at the rear-wheel-rising-time-point.

### BRIEF DESCRIPTION OF DRAWINGS

FIG. 1 is a diagram showing a configuration of the first embodiment of the present invention;

FIG. 2 is a diagram showing characteristics of a shock absorber shown in FIG. 1;

FIG. 3 is a diagram schematically shoving a situation where a front wheel of a vehicle reaches a rising point on a road surface;

FIG. 4 is a diagram schematically showing a situation where a rear wheel of the vehicle reaches the rising point on the road surface shown in FIG. 3;

FIG. 5 is a timing chart for explaining a vehicle behavior in. a case where a damping coefficient regarding the rear wheel is controlled by a method according to a comparative example;

FIG. 6 is a timing chart for explaining a vehicle behavior in a case where a damping coefficient regarding the rear wheel is controlled by a method according to the present invention;

FIG. 7 is a flow chart of a control routine executed in the first embodiment of the present invention;

FIG. 8 is a timing chart for explaining results of several kinds of simulations performed with changing respective damping coefficients regarding the front and rear wheels; and

FIG. 9 is a magnified view in which a part of the timing chart shown in FIG. 8 is magnified.

### EMBODIMENTS

### First Embodiment

### Configuration Of First Embodiment

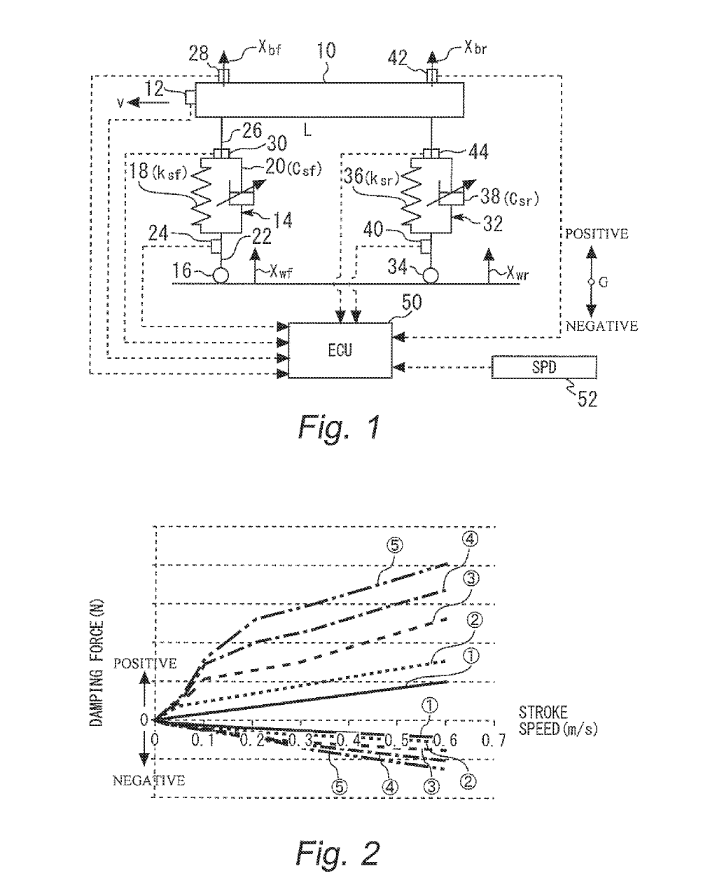

FIG. 1 is a diagram for explaining a configuration of a vehicle according to a first embodiment of the present invention. The vehicle shown in FIG. 1 has a vehicle body 10. FIG. 1 is a schematic side view of the vehicle body 10. Here, the left side in FIG. 1 is the front side of the vehicle, and the right side is the rear side. In FIG. 1, an arrow with a reference character “v” represents that the vehicle body 10 moves forward at the vehicle speed v.

A laser sensor 12 is attached to a front face of the vehicle body 10. The laser sensor 12 scans a road surface in front of the vehicle body 10. In the present embodiment, a detection signal provided by the laser sensor 12 is used for detecting locations and sizes of irregularities on the road surface. It should be noted that the laser sensor 12 can be replaced by another sensor such as an image sensor, as long as it can be used for detecting irregularities on the road surface.

A front wheel 16 is attached to the vehicle body 10 on the front side via a suspension device 14. The suspension device 14 and the front wheel 16 are provided on each of the left and right sides of the vehicle body 10. Since the structures on the left and right sides are substantially the same as each other, the suspension devices for the left and right front wheels are collectively referred to as the “suspension device 14”, and the left and right front wheels are collectively referred to as the “front wheel 16” in this Specification.

The suspension device 14 for the front wheel 16 is provided with a spring element 18 and a shock absorber 20. In FIG. 1, reference symbols Ksf and Csf denote a spring constant of the spring element 18 and a damping coefficient of the shock absorber 20, respectively.

FIG. 2 is a diagram showing characteristics of the shock absorber 20. In the present embodiment, the shock absorber 20 changes the damping coefficient Csf depending on a control current. Thus, as shown in FIG. 2, a relationship between a damping force and a stroke speed varies depending on the control current. For example, lines with reference numerals 1 to 5 in FIG. 2 represent relationships between the stroke speed and the damping force generated by the shock absorber 20 when different amounts of the control current are applied, respectively. In FIG. 2, a positive damping force is the damping force generated by the shock absorber 20 in a compression stroke, and a negative damping force is the damping force generated by the shock absorber 20 in an expansion stroke.

The suspension device 14 shown in FIG. 1 has an unsprung member 22 coupled to the front wheel 16 via a suspension arm. An unsprung mass acceleration sensor 24 is attached to the unsprung member 22. The unsprung mass acceleration sensor 24 can detect a vertical acceleration of an unsprung portion including the wheel, for each front wheel 16. Regarding this vertical acceleration, an upward acceleration has a positive sign, and a downward acceleration has a negative sign, in the following description.

The suspension device 14 is also coupled to the vehicle body 10. A sprung mass acceleration sensor 28 is attached to the vehicle body 10 at a position to which the suspension device 14 is coupled. The sprung mass acceleration sensor 28 can detect a vertical acceleration of the vehicle body 10 at a position corresponding to each front wheel 16. Regarding this vertical acceleration also, an upward acceleration has a positive sign, and a downward acceleration has a negative sign, in the following description.

In addition, a stroke sensor 30 is attached to the suspension device 14. The stroke sensor 30 can detect an amount of stroke of the shock absorber 20, that is, a relative displacement between the unsprung member 22 and a sprung member 26.

As shown in FIG. 1, a rear wheel 34 is attached to the vehicle body 10 on the rear side via a suspension device 32. As in the case of the front wheel side, the suspension devices provided on the left and right rear sides are collectively referred to as the “suspension device 32”, and the left and right rear wheels are collectively referred to as the “rear wheel 34”.

As in the case of the suspension device 14 for the front wheel 16, the suspension device 32 for the rear wheel 34 is provided with a spring element 36 and a shock absorber 38. In FIG. 1, reference symbols Ksr and Csr denote a spring constant of the spring element 36 and a damping coefficient of the shock absorber 38, respectively. As in the case of the shock absorber 20 for the front wheel, the shock absorber 38 for the rear wheel can change the damping coefficient Csr depending on the control current (see FIG. 2).

Moreover, as shown in FIG. 1, an unsprung mass acceleration sensor 40, a sprung mass acceleration sensor 42 and a stroke sensor 44 are attached to the suspension device 32 for the rear wheel 34. These components have substantially the same configurations and functions as those for the front wheel, and therefore, redundant descriptions thereof are omitted here.

The configuration shown in FIG. 1 is provided with an ECU (Electronic Control Unit) 50. The various sensors provided for each wheel and the laser sensor 12 disposed on the vehicle body 10 descried above are all electrically connected to the ECU 50. In addition, a vehicle speed sensor 52 that generates a signal indicative of the vehicle speed v is electrically connected to the ECU 50.

### Relationship Between Irregularities On Road Surface And Vehicle Behavior

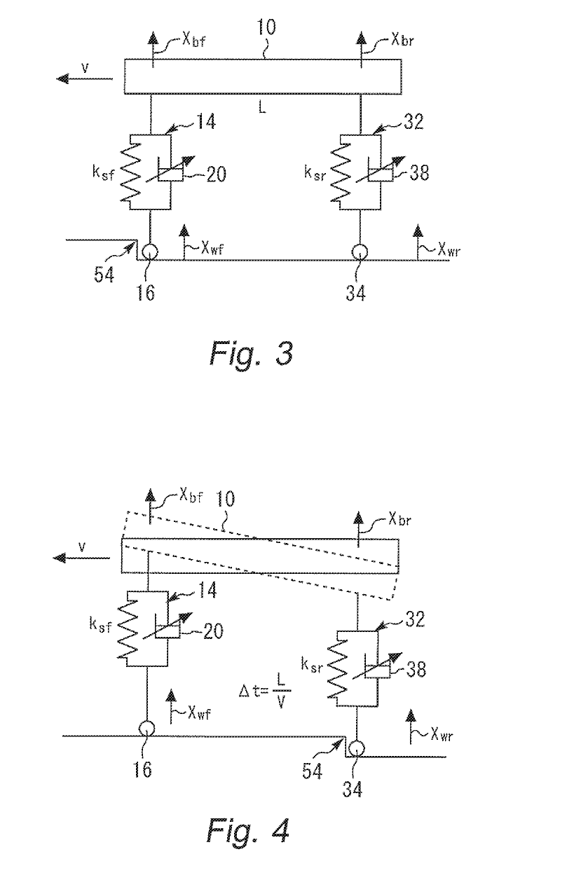

FIG. 3 shows a situation where the vehicle is travelling and immediately before the front wheel 16 reaches a rising point 54 on the road surface. Here, reference symbols Xwf and Xwr in FIG. 3 respectively denote displacements of the front wheel 16 and the rear wheel 34 caused by an input from the road surface. The displacements Xwf and Xwr are hereinafter referred to as an “unsprung mass displacement”. Reference symbols Xbf and Xbr in FIG. 3 respectively denote displacements of the vehicle body 10 at the positions of the front wheel 16 and the rear wheel 34. The displacements Xbf and Xbr are hereinafter referred to as a “sprung mass displacement”.

The unsprung mass displacements Xwf and Xwr and the sprung mass displacements Xbf and Xbr can be computed by a publicly known method based on the detection signals from the variety of sensors shown in FIG. 1. In the following, the method of computing the unsprung mass displacement Xwf and the sprung mass displacement Xbf associated with the front wheel 16 will be described as an example.

The unsprung mass displacement Xwf regarding the front wheel 16 corresponds to the second integral value of the unsprung mass acceleration at the position of the front wheel 16. Therefore, the ECU 50 can compute the unsprung mass displacement Xwf regarding the front wheel 16 by integration of the detection signal from the unsprung mass acceleration sensor 24. Alternatively, in the present embodiment, the unsprung mass displacement Xwf may be computed based on the detection value detected by the laser sensor 12, The ECU 50 can determine, based on the detection signal from the laser sensor 12, the location and size (height) of an irregularity on the road surface in front of the vehicle. Once the location of the irregularity is known, it is possible to compute, based on the vehicle speed v and the location, a timing when the front wheel 16 reaches the irregularity, a timing when the front Wheel 16 goes over the irregularity, a timing when the front wheel 16 overcomes the irregularity, and the like. Then, by analyzing the computation result and. the size (height) of the irregularity in combination, the unsprung mass displacement Xwf can be computed in real time, It should be noted that the unsprung mass displacement sensor 24 or the laser sensor 12 serves as a road surface input sensor for generating a signal corresponding to the vertical movement of each wheel.

On the other hand, the sprung mass displacement Xbf regarding the front wheel 16 corresponds to the second integral value of the sprung mass acceleration at the position of the front wheel 16. Therefore, the ECU 50 can compute the sprung mass displacement Xbf regarding the front wheel 16 by integration of the detection signal from the sprung mass acceleration sensor 28. Also, the sprung mass displacement Xbf corresponds to a sum of the unsprung mass displacement Xwf and the stroke amount of the shock absorber 20. Therefore, the ECU 50 can also compute the sprung mass displacement Xbf based on the unsprung mass displacement Xwf computed by the above-described method and the detection signal from the stroke sensor 30. It should be noted that the sprung mass acceleration sensor 28 or the stroke sensor 30 serves as a sprung mass behavior sensor for generating a signal corresponding to a vertical movement of the vehicle body 10 at a position of the each wheel.

Regarding the rear wheel 34, the ECU 50 can also compute the unsprung mass displacement Xwr and the sprung mass displacement Xbr based on the output values from the variety of sensors shown in FIG. 1. The method of computing these values is substantially the same as that for the front wheel side, and thus redundant descriptions thereof are omitted here.

In the situation shown in FIG. 3, both the front wheel 16 and the rear wheel 34 are on a flat road surface. Under this situation, no large input force is transmitted from the road surface to the front wheel 16 and the rear wheel 34. Therefore, as long as such the situation continues, no significant change is caused in the unsprung mass displacements Xwf and Xwr and the sprung mass displacements Xbf and Xbr.

When the vehicle further moves forward from the situation shown in FIG. 3, the front wheel 16 climbs the rising point 54. At this time, the front wheel 16 receives an input force from the road surface and is greatly pushed up. The lift of the front wheel 16 is transmitted to the vehicle body 10 through the suspension device 14. As a result, the sprung mass at the position of the front wheel 16 is first displaced upward and then performs an oscillation behavior according to characteristics of the suspension device 14.

This oscillation is transmitted to the suspension device 32 for the rear wheel 34 through the vehicle body 10. Therefore, after the front wheel 16 goes over the rising point 54, the vehicle body 10 at the position of the rear wheel 34 also is subject to the oscillation,

FIG. 4 shows a situation at a time point when a time of Δt (=L/v) has elapsed after the situation shown in FIG. 3 occurs. Here, the reference character L denotes a wheelbase of the vehicle. Therefore, the time Δt mentioned above means a time required for the vehicle to move forward for a distance between the front wheel 16 and the rear wheel 34. In other words, FIG. 4 shows a situation immediately before the rear wheel 34 reaches the rising point 54 shown in FIG. 3. A dashed line rectangle shown in FIG. 4 schematically represents inclination of the vehicle 10 due to a difference in height between the front wheel 16 and the rear wheel 34.

As described above, immediately after the front wheel 16 climbs the rising point 54, the oscillation of the vehicle body 10 is caused. At this time, the damping coefficient Csr regarding the rear wheel 34 being set to a high value is desirable for suppressing a pitch behavior of the vehicle body 10. However, if the damping coefficient Csr is still kept at the high value when the rear wheel 34 climbs the rising point 54, a strong push-up is transmitted to the vehicle body 10, which deteriorates vehicle ride comfort. Therefore, under a situation where the front wheel 16 and the rear wheel 34 successively go over the same rising, point 54, how the damping coefficient Csr regarding the rear wheel 34 is controlled has a great influence on the characteristics of the vehicle.

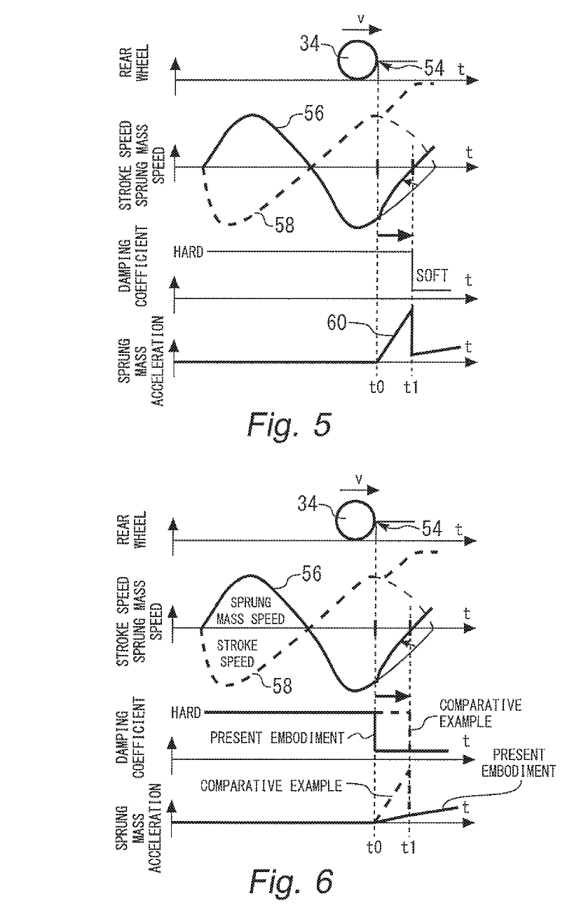

FIG. 5 is a timing chart for explaining a vehicle behavior that occurs when an example of a skyhook control (referred to as a “comparative example”, hereinafter), which is known as a method of controlling the damping force, is applied to the shock absorber 38.

In FIG. 5, the uppermost part shows a situation where the rear wheel 34 reaches the rising point 54 on the road surface at a time t0. The second part from the top shows waveforms of a sprung mass speed 56 regarding the rear wheel 34 and a stroke speed 58 of the shock absorber 38. The sprung mass speed 56 is an integral value of the sprung mass acceleration and therefore can be calculated based on the detection signal from the sprung mass acceleration sensor 42. In the present embodiment, the stroke speed 58 is defined as “(absolute unsprung mass speed) - (absolute sprung mass speed)” and can be calculated by differentiation of the detection signal from the stroke sensor 44, for example. The third part from the top shows a waveform of the damping coefficient Csr that is required for the shock absorber 38 of the rear wheel 34 by the control according to the according to the comparative example. The bottom part shows a waveform of a sprung mass acceleration 60 at the position of the rear wheel 34.

The timing chart shown in FIG. 5 is based on the situation that the front wheel 16 of the vehicle has already crossed the rising point 54 before the time t0 and the resultant oscillation of the vehicle body 10 has occurred. In the control according to the comparative example, the damping coefficient for a wheel at the position where the sprung mass behavior is stable is set to a soft-side value, and the damping coefficient for a wheel at the position where the sprung mass behavior is determined to exceed a predefined standard is set to a hard-side value higher than the soft-side value. In this example, the damping coefficient Csr for the rear wheel 34 is set to the hard-side value at the time when the front wheel 16 climbs the rising point 54 and the resultant oscillation of the vehicle body 10 occurs. In the control according to the comparative example, the damping coefficient Csr is allowed to be set to the soft-side value after the sprung mass speed 56 at the position of the rear wheel 34 exceeds zero.

In the example shown in FIG. 5, the sprung mass speed 56 is a negative value at a time t0 (see the second part from the top). Thus, at this time point, the shock absorber 38 for the rear wheel 34 is required to have the damping coefficient Csr that corresponds to the hard-side value. Then, the rear wheel 34 goes over the rising point 54 under the condition that the damping coefficient Csr is the hard-side value. As a result, the sprung mass acceleration 60 abruptly increases after the time t0 (see the bottom part).

The effect of the rear wheel 34 climbing the rising point 54 influences not only the sprung mass acceleration 60 but also the sprung mass speed 56 and the stroke speed 58. More specifically, after the time t0, both the sprung mass speed 56 and the stroke speed 58 increase at higher rates than before the time t0. As a result, in the example shown in FIG. 5, at the time t1, the sprung mass speed 56 reaches zero and the damping coefficient Csr of the shock absorber 38 is set to the soft-side value. Since the damping coefficient Csr is set to the soft-side value, the sprung mass acceleration 60 regarding the rear wheel 34 abruptly decreases at the time t1.

According to the control in the comparative example described above, the damping coefficient Csr regarding the rear wheel 34 can be set to the hard-side value at the time when the vehicle body 10 start to oscillate due to the front wheel 16 reaching the rising point 54 on the road surface. Thus, according to the control, the pitch behavior of the vehicle body 10 triggered when the front wheel 16 crosses the rising point 54 can be effectively suppressed.

Furthermore, according to the control, the damping coefficient Csr regarding the rear wheel 34 can be set to the soft-side value in a fairly short period after the rear wheel 34 reaches the rising point 54 on the road surface (i.e. a period from the time t0 to the time t1). Thus, according to the control, it is possible to restore the comfortable ride within a short period after the rear wheel 34 goes over the rising point 54.

### Characteristics Of First Embodiment

However, according to the control in the comparative example described above, when the rear wheel 34 goes over the rising point 54 on the road surface at the time t0, the high sprung mass acceleration 60 inevitably occurs for a short time. On the other hand, according to the present embodiment, it is possible to prevent such the high sprung mass acceleration from occurring, by switching the damping coefficient Csr for the rear wheel 34 to the soft-side value at the same time as the rear wheel 34 reaches the rising point 54.

FIG. 6 is a timing chart for explaining a vehicle behavior in a case where the control according to the present embodiment for achieving the above-mentioned function is applied to the shock absorber 38. According to the present embodiment, as shown in the third part from the top, the damping coefficient Csr regarding the rear wheel 34 is switched from the hard-side value to the soft-side value at the time t0 when the rear wheel 34 reaches the rising point 54 on the road surface. In this case, the push-up force caused by the rising point 54 is input to the “softened” rear wheel 34. As a result, as shown in the bottom part, the sprung mass acceleration after the time t0 becomes sufficiently smaller than that in the case of the comparative example. Thus, according to the control of the present embodiment, both stabilization of the vehicle attitude and comfortable ride when the vehicle crosses the rising point 54 on the road surface can be achieved at a high level.

### Processing Performed By ECU 50

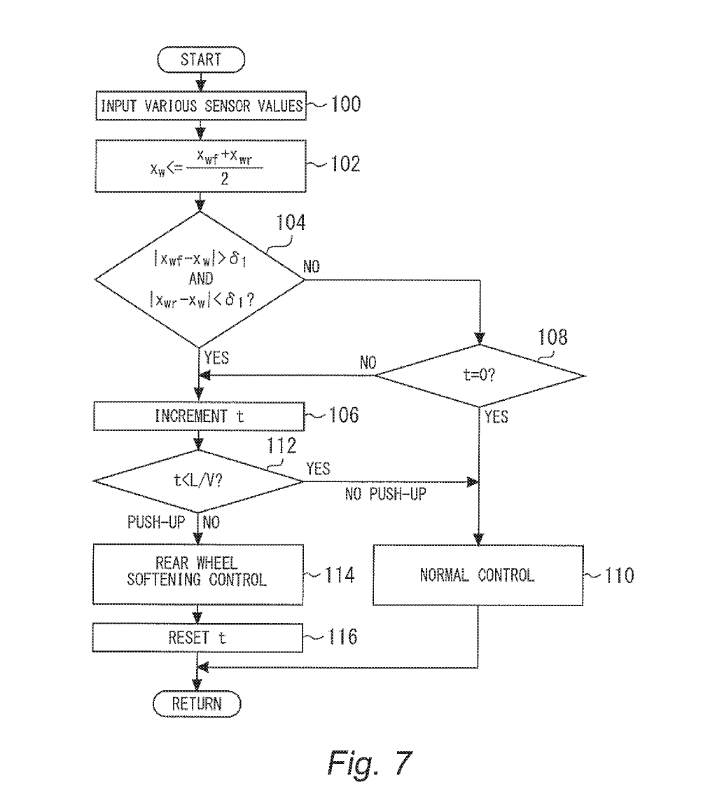

FIG. 7 is a flowchart showing a routine performed by the ECU 50 to achieve the functions described above in the present embodiment. The routine shown in FIG. 7 is repeatedly started every predetermined sampling time after the vehicle according to the present embodiment starts up.

In the routine shown in FIG. 7, the detection signals obtained by the variety of sensors of the vehicle shown in FIG. 1 are first input to the ECU 50 (Step 100). More specifically, in this example, the detection signals by the laser sensor 12, the unsprung mass acceleration sensors 24 and 40, the sprung mass acceleration sensors 28 and 42, the stroke sensors 30 and 44, and the vehicle speed sensor 52 are input to the ECU 50.

Next, a road plane amount Xw which indicates an average height of the road surface is calculated (Step 102). In this step, first, the unsprung mass displacement Xwf for the front wheel and the unsprung mass displacement Xwr for the rear wheel are calculated based on the sensor values obtained at the current sampling time. Subsequently, an average value (Xwf+Xwr)/2of these values is calculated. The average value corresponds to the unsprung mass height at the position of the center of the vehicle at the current sampling time. Then, the average value (Xwf+Xwr)/2obtained in the current routine is reflected, with a predetermined smoothing rate, in the road plane amount Xw(n−1) calculated in the preceding routine to update the road plane amount Xw to be the updated value. The road plane amount Xw thus calculated is a smoothed value of the unsprung mass height at the position of the center of the vehicle and can be treated as an average height of the road surface on which the vehicle is traveling.

Next, whether or not the front wheel 16 of the vehicle reaches the rising point 54 on the toad surface is determined based on the unsprung mass displacements Xwf and Xwr and the road plane amount Xw (Step 104). More specifically, in this step, whether both the following two conditions are met or not is determined.

|Xwf−Xw|>δ1 (Condition 1)

|Xwf−Xw|<δ1 (Condition 2)

Here, δ1 is a threshold for determining whether or not there is a bump that should be regarded as the rising point 54 on the road surface according to the present embodiment. In other words, δ1 is a threshold for determining whether or not there is a bump with a size that is expected to cause an oscillation of the vehicle body 10 that should be suppressed, The ECU 50 holds, as the threshold δ1, a minimum difference between the unsprung mass displacement Xwf or Xwr and the road plane amount Xw that is caused when the wheel crosses such the bump. Thus, if the condition 1 described above is met, it is possible to judge that a displacement of the front wheel 16 equivalent to the displacement that occurs when going over the rising point 54 has occurred. Also, if the condition 2 described above is met, it is possible to judge that such a significant displacement of the rear wheel 34 has not occurred. If both the conditions 1 and 2 are met, it is possible to judge that the rear wheel 34 is on a flat road surface and only the front wheel has gone over the rising point 54.

If it is determined that both of the conditions 1 and 2 described above are met, then a counter t is incremented (Step 106). The counter t is a counter for measuring the time Δt=L/v, that is, the time required for the vehicle to travel the distance equal to the wheelbase L after the front wheel 16 of the vehicle reaches the rising point 54. The counter t is reset to zero in an initialization step and thus has a value other than zero if the process of this Step 106 is performed.

If it is determined in the Step 104 that any of the conditions 1 and 2 described above is not met, it is possible to judge that a situation where only the front wheel 16 is located on a high place is not occurred. In this case, the ECU 50 then determines whether or not the count of the counter t is zero (Step 108).

If it is determined that the count of the counter t is zero, it is possible to judge that there is no record that the process of Step 106 has been performed. In this case, it is judged that the front wheel 16 has not gone over the bump but the vehicle continues traveling on a flat road, and thus a normal control is thereafter performed with regard to the damping coefficient Csr for the rear wheel 34 (Step 110). More specifically, in this step, the so-called skyhook control is performed. For example, when the vehicle body 10 being the sprung mass moves downward significantly, the damping coefficient Csr of the shock absorber 38 is set to the hard-side value in order to strengthen support from the below. When the sprung mass moves upward significantly, the damping coefficient Csr is set to the hard-side value in order to strengthen suppression from the above. On the other hand, when there is no significant vertical movement of the sprung mass, the damping coefficient Csr is set to the soft-side value. According to this normal control, it is possible to keep the stable vehicle attitude and ensure the comfortable ride.

On the other hand, if it is determined in the Step 108 that the count of the counter t is not zero, it is possible to judge that the above-mentioned Step 106 has been performed in the previous cycle. In other words, it is possible to judge that the situation where the front wheel 16 has gone over the rising point 54 is detected in the previous cycle. In this case, the Step 106 is performed also in the current process cycle in order to increment the counter t.

After the process of Step 106 is performed, it is determined next whether or riot the count of the counter t has reached L/v (Step 112). If it is determined that a condition of t<L/v is met, it is possible to judge that the rear wheel 34 does not yet reached the rising point 54. In this case, the above-described normal control in the Step 110 is then performed. When the Step 110 is performed following the Step 112, the sprung mass at the position of the rear wheel 34 is subject to the large oscillation caused by the fact that the front wheel 16 has gone over the rising point 54, In this case, according to the normal control, the damping coefficient Csr regarding the rear wheel 34 is set to the hard-side value. As a result, the oscillation at the rear side of the vehicle body 10 is suppressed, and thus the pitch behavior of the vehicle body 10 is properly suppressed.

On the other hand, if it is determined in the Step 112 that the condition of t<L/v is not met, it is possible to judge that the rear wheel 34 has reached the rising point 54. In this case, the ECU 50 performs a “rear wheel softening control” that sets the damping coefficient Csr regarding the rear wheel 34 to the soft-side value, regardless of other requests (Step 114). As a result, the damping coefficient Csr regarding the rear Wheel 34 is quickly switched to the soft-side value. The soft-side value used here is a value of the damping coefficient that provides a lower damping force as compared to the case of the hard-side value used in the normal control. By using such the damping coefficient at the timing when the rear wheel 34 goes over the rising point 54, the push-up force transmitted from the rear wheel 34 to the vehicle body 10 is reduced, and thus the ride comfort of the vehicle is improved. Thus, according to the control in the present embodiment, it is possible not only to keep the attitude of the vehicle body 10 stable after the front wheel 16 goes over the rising point 54 but also to keep the excellent ride comfort of the vehicle at the time when the rear wheel 34 goes over the rising point 54.

In the routine shown in FIG. 7, following the Step 114, a process of resetting the counter t is performed (Step 116). Thus, when this routine is started next time and it is determined in the Step 104 that the conditions are not met, the normal control is performed without performing the process of Step 106.

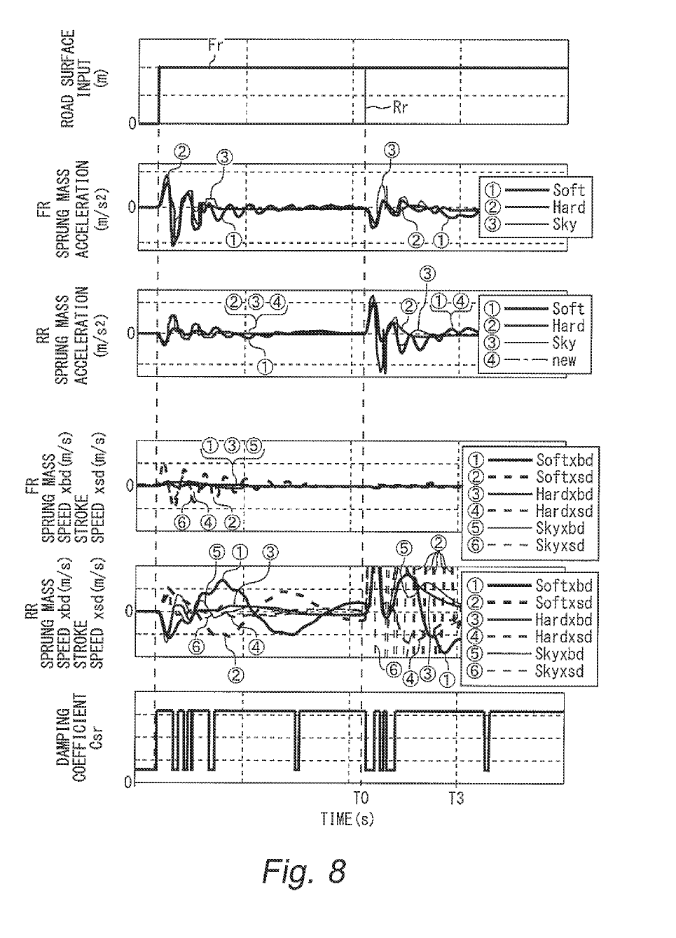

FIG. 8 shows results of simulations performed with changing respective damping coefficients Csf and Csr regarding the front wheel 16 and the rear wheel 34 as appropriate. In FIG. 8, the top part shows inputs from the road surface to the front wheel 16 (Fr) and the rear wheel 34 (Rr). The second part from the top shows the sprung mass acceleration for the front wheel 16, and the third part from the top shows the sprung mass acceleration for the rear wheel 34. The fourth part from the top shows the sprung mass speed and the stroke speed for the front wheel 16, and the fifth part from the top shows the sprung mass speed and the stroke speed for the rear wheel 34. The bottom part shows the damping coefficient Car of the shock absorber 38 for the rear wheel 34.

Moreover, in FIG. 8, reference symbols attached to the waveforms have the following meanings.

Soft: a waveform in a case where the damping coefficient is always set to the soft-side value

Hard: a waveform in a case where the damping coefficient is always set to the hard-side value

Sky: a waveform in a case where the damping coefficient is controlled in the method according to the comparative example

new: a waveform in a case where the damping coefficient is controlled in the method according to the present embodiment

Softxbd: the sprung mass speed in the case where the damping coefficient is always set to the soft-side value

Softxsd: the stroke speed in the case where the damping coefficient is always set to the soft-side value

Hardxbd: the sprung mass speed in the case where the damping coefficient is always set to the hard-side value

Hardxsd: the stroke speed in the case where the damping coefficient is always set to the hard-side value

Skyxbd: the sprung mass speed in the case where the damping coefficient is controlled in the method according to the comparative example

Skyxsd: the stroke speed in the case where the damping coefficient is controlled in the method according to the comparative example

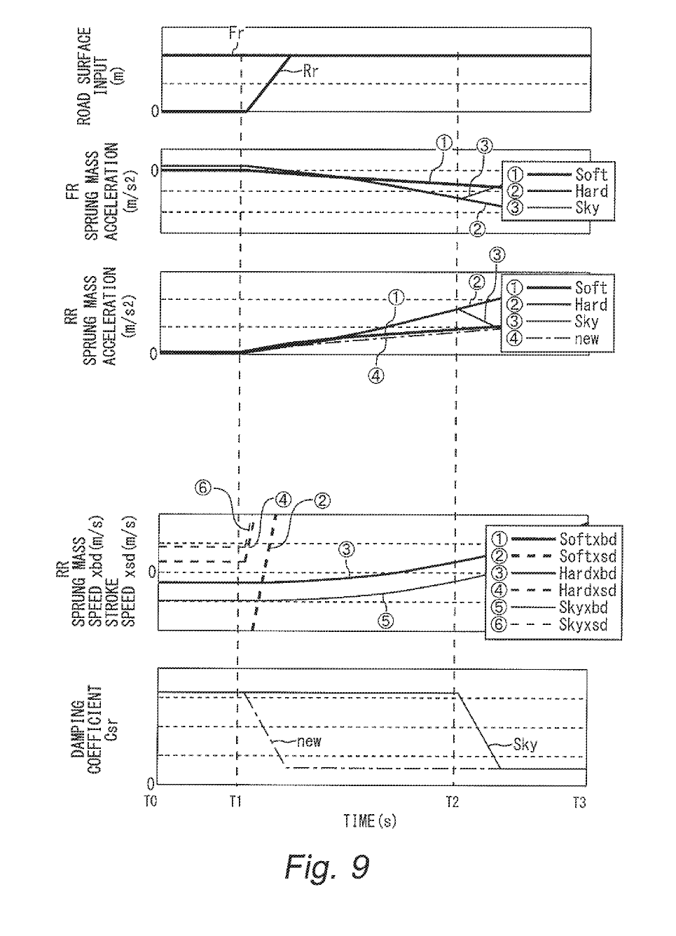

FIG. 9 is a magnified view in which a part from a time T0 to a time T3 in the timing chart shown in FIG. 8 is extracted and magnified, As shown in the bottom part of FIG. 9, according to the control (new) in the present embodiment, the control current for the shock absorber 38 for the rear wheel 34 is switched from the hard-side value to the soft-side value at the time T1, As a result, as shown by the waveform (4) in the third part from the top, the sprung mass acceleration regarding the rear wheel 34 is sufficiently suppressed after the time T1, according to the control (new) in the present embodiment.

On the other hand, according to the method of the comparative example, as shown by the waveform (5) in the fourth part from the top of FIG. 9, the sprung mass speed regarding the rear wheel 34 does not reach zero for some time after the time T1, and as a result, the control current for the damping coefficient is maintained at the hard-side value until a time T2. As a result, as shown by the waveform (3) in the third part from the top, the sprang mass acceleration regarding the rear wheel 34 substantially increases in the period from the tune T1 to the time T2, according to the method of the comparative example.

From the results of the simulations described above, it is obvious that the control according to the present embodiment is more effective for improving the ride comfort of the vehicle, as compared to the method according to the comparative example.

### Modification Examples Of First Embodiment

In the first embodiment described above, the control current for the shock absorber 38 for the rear wheel 34 is switched when the time period Δt=L/v has elapsed after the front wheel 16 reaches the rising point 54 on the road surface. However, the timing for the switching can also be determined by taking a delay time of an actuator or the like into consideration. That is, if there is a delay time Td from the time when the ECU 50 outputs the switching command to the time when the damping coefficient Csr is actually switched, the ECU 50 can output the switching command at a timing when a time period “L/v-Td” has elapsed after the front wheel 16 reaches the rising point 54.

In the first embodiment described above, the left and right front wheels are not discriminated, and the left and right rear wheels are not discriminated. However, the determination of whether or not the front wheel 16 goes over the rising point 54 and the switching of the damping coefficient Csr regarding the rear wheel 34 may be performed separately for the left and right wheels or performed by treating the left and right wheels as a whole.

In the first embodiment described above, the time point when the time period L/v has elapsed after the front wheel 16 reaches the rising point 54 is regarded as the time point when the rear wheel 34 reaches the rising point 54. However, a method for specifying the time point when the rear wheel 34 reaches the rising point 54 is not limited to the above-mentioned method. For example, the time point when the rear wheel 34 reaches the rising point 54 may be directly calculated from the results of detection by the laser sensor 12 or a substitute image sensor.

What is claimed is:

1. A control device for a vehicle suspension,
the vehicle suspension including a spring element and a shock absorber whose damping coefficient is variable, the spring element and the shock absorber being provided for each wheel of a vehicle,
the control device comprising:
a road surface input sensor configured to generate a signal corresponding to a vertical movement of the each wheel;
a sprung mass behavior sensor configured to generate a signal corresponding to a vertical movement of a vehicle body at a position of the each wheel; and
a control unit configured to supply, based on the signal from the road surface input sensor and the signal from the sprung mass behavior sensor, a command signal specifying the damping coefficient to the shock absorber of the each wheel,
wherein the control unit performs:
a normal control that sets the damping coefficient to a hard-side value with regard to a wheel at a position where determination based on the signal from the sprung mass behavior sensor indicates occurrence of a sprung mass behavior exceeding a standard; and
a rear wheel softening control that sets the damping coefficient regarding a rear wheel to a soft-side value lower than the hard-side value, when determining, based on the signal from the road surface input sensor, that a rear-wheel-rising-time-point when the rear wheel reaches a rising point on a road surface comes.

2. The control device for the. vehicle suspension according to claim 1, further comprising: a vehicle speed sensor configured to generate a signal corresponding to a vehicle speed,
wherein the rear wheel softening control includes:
a computation process of computing, based on the signal from the road surface input sensor, a front-wheel-rising-time-point when a front wheel reaches the rising point on the road surface;
a process of calculating, based on the vehicle speed and a wheelbase, a required time from the front-wheel-rising-time-point to the rear-wheel-rising-time-point; and
a command process of outputting a change command of changing the damping coefficient such that the damping coefficient is switched when the required time elapses after the front-wheel-rising-time-point.

3. The control device for the vehicle suspension according to claim 2,
wherein the computation process includes:
a process of calculating, based on the signal from the road surface input sensor, a road plane amount corresponding to an average height of the road surface;
a process of computing, based on the signal from the road surface input sensor on a side of the front wheel, a vertical position of the front wheel;
a process of computing, based on the signal from the road surface input sensor on a side of the rear wheel, a vertical position of the rear wheel; and
a process of setting, as the front-wheel-rising-time-point, a time point when a difference between the vertical position of the front wheel and the road plane amount exceeds a threshold while a difference between the vertical position of the rear wheel and the road plane amount remains less than the threshold.

4. The control device for the vehicle suspension according to claim 2,
wherein the computation process and the command process are performed independently for each of a pair of a left front wheel and a left rear wheel and a pair of a right front wheel and a right rear wheel.

5. The control device for the vehicle suspension according to claim 2,
wherein the command process includes:
a process of reading a time lag from an output time of the change command to a time when the damping coefficient is actually changed; and
a process of outputting the change command the time lag before a time point when the required time elapses after the front-wheel-rising-time-point.
